(19) United States
(12) Patent Application Publication
(10) Pub. No.: US 2008/0109404 A1
(43) Pub. Date: May 8, 2008

(54) LOCATION DEPENDENT MUSIC SEARCH

(75) Inventor: Anders O. HOLM, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/556,421

(22) Filed: Nov. 3, 2006

(51) Int. Cl. G06F 7/10; G06F 17/30

(52) U.S. Cl. 707/3; 707/E17.014

(57) ABSTRACT

A portable device may perform a location dependent music search. During the search, the portable device determines location information that identifies a location of the portable device, makes a request that includes the location information to a database, obtains a list of music sources associated with the location information from the database as a result of a search performed based on the request, selects a music source from the list, and outputs an audio signal associated with the selected music source,

### TECHNICAL FIELD OF THE INVENTION

Implementations described herein pertain to searching pieces of music and, in particular, to methods and apparatuses for allowing a user to search and access pieces of music based on the user's location.

### DESCRIPTION OF RELATED ART

Many people associate a physical location or a place to songs or pieces of music. In visiting or arriving at the place, they may remember the songs or the pieces of music and wish to hear them. They may also appreciate being supplied, automatically or after a request, information about the songs or pieces of music associated with the place.

### SUMMARY

According to one aspect, a method may comprise determining location information that identifies a location of a portable device, making a request that includes the location information to a database, obtaining a list of music sources associated with the location information from the database as a result of a search performed based on the request, selecting a music source from the list, and outputting an audio signal associated with the selected music source.

Additionally, determining location information may include receiving signals from Global Positioning System (GPS) satellites or one or more base stations, and determining the location information based on the received signals.

Additionally, the method may further comprise editing or creating a database record that includes a set of metadata for a music source and a geographical key, and adding or saving the database record to the database.

Additionally, the method may further comprise authenticating a user of the portable device at the database before editing, creating, adding or saving the database record.

According to another aspect, a method may comprise determining location information that identifies a location of a portable device, transmitting a request that includes the location information to a remote map database, receiving a geographical key from the remote map database as a result of a search performed based on the request, submitting a query based on the geographical key to a local metadata database, obtaining a list of music sources associated with the location information from the local metadata database as a result of the query, and outputting an audio signal associated with the selected music source.

According to yet another aspect, a portable electronic device may comprise a position signal receiver for determining location information that identifies a location of the portable electronic device, one or more processors configured to: submit a query to a database, the query including the location information; accept a list of music sources associated with the location information from the database as a result of the query submitted to the database; and select a music source from the list, wherein the portable electronic device produces an audio signal associated with the selected music source when the music source is selected from the list.

Additionally, the database may be included in a remote server.

Additionally, the database may be included in the portable electronic device.

Additionally, the processor may be further configured to accept user inputs and the query may farther include user inputs.

Additionally, the user inputs may include one or more of the following: a distance or location information.

Additionally, the database may include a map database and a metadata database.

Additionally, the metadata database may include a record, the record comprising a geographical key and a set of metadata for a music source.

Additionally, the map database may include a record, the record comprising location information and a geographical key that corresponds to the location information.

Additionally, the query may further include a distance for obtaining geographical keys whose locations fall within the distance from the location of the portable electronic device.

According to a further aspect, a database server may comprise a network interface, through which the database server communicates with a portable electronic device that is configured to send a request for a list of music sources, the request including a location of the portable electronic device, and one or more processors configured to: receive the request from the portable electronic device, submit a music query for a list of music sources to a database, the music query including the location of the portable electronic device, and obtain a list of music sources associated with the location as a result of submitting the music query, wherein the database server is configured to transmits the list of music sources obtained from the music query to the portable electronic device through the network interface.

Additionally, the database may comprise a map database and a metadata database.

Additionally, the map database may include a geographical record, the geographical record including location information and a geographical name, and the metadata database may include a metadata record, the metadata record including a set of metadata for a music source and a geographical name associated with the music source.

According to yet another aspect, a device may comprise means for determining location information that identifies a location of the device, means for submitting a request that includes the location information of the device to a remote device, means for accepting records of metadata about music sources associated with the location information from the remote device based on the request, means for selecting a music source whose record is among the accepted records, and means for generating an acoustic signal associated with the selected music source.

Additionally, the remote device may include means for storing and searching geographical records, at least one geographical record including location information and a geographical name, and means for storing and searching metadata records, at least one metadata record including a set of metadata for a music source and a geographical name associated with the music source.

According to yet another aspect, a remote server may comprise means for receiving a request for a list of music sources from a device, the request including location information that identifies a location of the device, means for searching a database for a list of music sources associated with the location information, and means for transmitting the list of music sources obtained from searching the database to the device.

### BRIEF DESCRIPTION OF THE DRAWINGS

The accompanying drawings, which are incorporated in and constitute a part of this specification, illustrate embodiments of the teachings described herein, together with the description, explain the teachings. In the drawings,

FIG. 1 depicts an exemplary network in which systems and methods described herein may be implemented;

FIG. 2 depicts a functional block diagram of the exemplary portable electronic device of FIG. 1;

FIG. 3 illustrates a block diagram of the exemplary database server of FIG. 1;

FIG. 4 illustrates an exemplary database in the database server or in the portable electronic device of FIG. 1;

FIG. 5 depicts an exemplary tabular representation of the metadata database of FIG. 4;

FIG. 6 shows a flowchart of a process for requesting music sources;

FIG. 7 illustrates a flowchart of a process for responding to a request for music sources;

FIG. 8 shows a flowchart of a procedure for creating or editing portions of metadata database of FIG. 4;

FIG. 9 illustrates another exemplary network in which systems and methods described herein can be implemented.

FIG. 10 shows a flowchart of a process for requesting music sources using the portable electronic device of FIG. 9; and

FIG. 11 illustrates a flowchart for processing location and distance information at the database server of FIG. 9.

### DETAILED DESCRIPTION OF EMBODIMENTS

The following detailed description refers to the accompanying drawings. The same reference numbers in different drawings may identify the same or similar elements.

### Exemplary Network

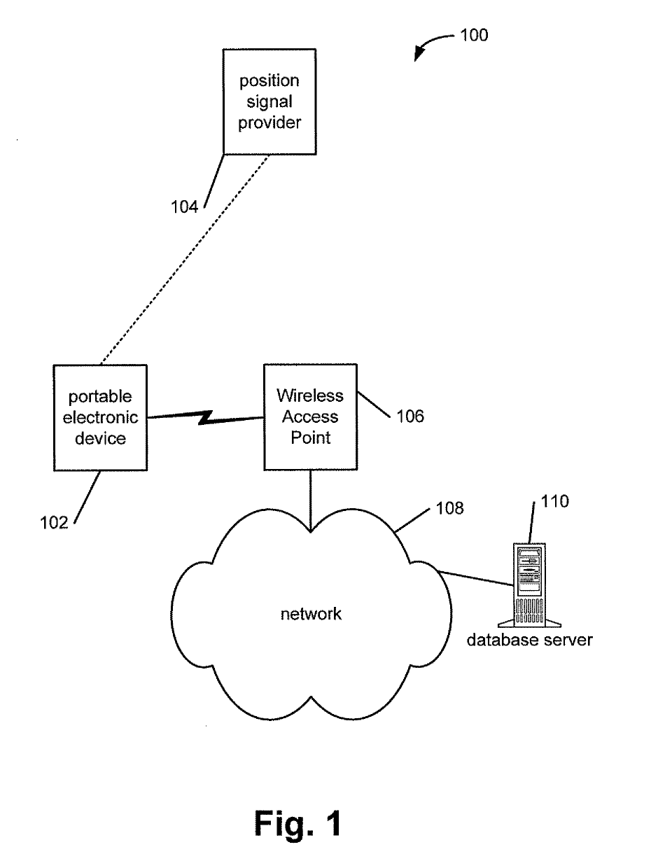

FIG. 1 illustrates an exemplary network 100 in which systems and methods described herein can be implemented. Network 100 may include portable electronic device 102, position signal provider 104, wireless access point (WAP) 106, network 108 and database server 110. In practice, network 100 may include more or fewer portable electronic devices, position signal providers, WAPs, networks, and/or database servers.

Portable electronic device 102 may include a radiotelephone; a personal communications system (PCS) terminal that may combine a cellular radiotelephone with data processing, facsimile, and data communications capabilities; a mobile telephone; an electronic notepad; a laptop; a personal digital assistant (PDA) that can include a radiotelephone, pager, Internet/intranet access, web browser, organizer, calendar, and/or Global Positioning System (GPS) receiver; or any device with sufficient computing power and memory to support functions described herein. Portable electronic device 102 may receive radio signals from position signal provider 104, determine its location, accept and process inputs from its user, transmit requests for music information to database server 110, and receive and process responses from database server 110.

Position signal provider 104 may include a device for communicating signals that carry position information, such as a base station or a Global Positioning System (GPS) satellite. In FIG. 1, position signal provider 104 may communicate position information to portable electronic device 102.

WAP 106 may include a device for accessing network 108, such as a router that is able to receive and transmit wireless and/or wired signals, or any other device that provides access to a network. WAP 106 may communicate with portable electronic device 102 using any wireless communication protocol.

Network 108 may include the Internet, an ad hoc network, a local area network (LAN), a wide area network (WAN), a metropolitan area network (MAN), a cellular network, a public switched telephone network (PSTN), any other network, or combinations of networks.

Database server 110 may include a computer system that may maintain one or more databases. In an alternate implementation, database server 110 may include a portable electronic device, possibly similar to portable electronic device 102. Database server 110 may receive a request for information related to music from portable electronic device 102, process the request, and transmit requested information to portable electronic device 102.

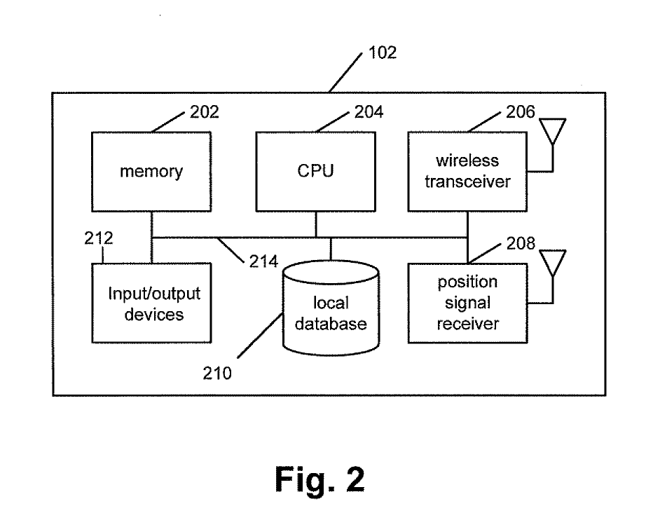

FIG. 2 illustrates an exemplary functional block diagram of portable electronic device 102 of FIG. 1. Portable electronic device 102 may include memory 202, central processing unit (CPU) 204, wireless transceiver 206, position signal receiver 208, local database 210, input/output devices 212, and communications interface 214. Memory 202 may include static memory, such as read only memory (ROM), and/or dynamic memory, such as random access memory (RAM), for storing data and machine-readable instructions. Memory 202 may also include storage devices, such as a floppy disk, CD ROM, CD read/write (R/W) disc, flash memory, as well as other types of storage devices. CPU 204 may include one or more processors, microprocessors, and/or processing logic capable of controlling portable electronic device 102. Wireless transceiver 206 may include a transmitter and receiver for communicating with WAP 106 using a wireless communications protocol. Position signal receiver 208 may include a receiver, such as a GPS receiver, for receiving signals from position signal provider 104. Local database 210 may include one or more repositories of information related to physical locations and music. In one implementation, local database 210 may retrieve information related to music when portable electronic device 102 presents local database 210 with location information. Input/output devices 212 may include a printer, keyboard, mouse, speaker, microphone, digital camera, digital video camera, and/or other types of devices for converting physical events or phenomena to and from digital signals that pertain to portable electronic device 102. Communications interface 214 may provide an interface through which components of portable electronic device 102 can communicate.

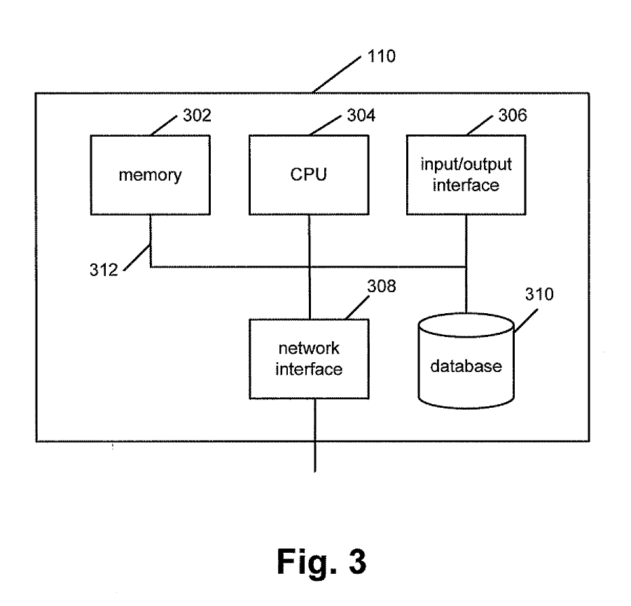

FIG. 3 is an exemplary functional block diagram of database server 110. Database server 110 may include memory 302, CPU 304, input/output interface 306, network interface 308, database 310 and communications interface 312. Memory 302 may include static memory, such as ROM, and/or dynamic memory, such as RAM, for storing data and machine-readable instructions. Memory 302 may also include storage devices, such as a floppy disk, CD ROM, CD R/W disc flash memory, as well as other types of storage devices. CPU 304 may include one or more processors, microprocessors, and/or processing logic capable of controlling database server 110. Input/output interface 306 may provide interfaces to database server 110 and may include interface to a printer, keyboard, mouse, speaker, microphone, digital camera, digital video camera, and other types of devices which convert physical events or phenomena to and from digital signals. Network interface 308 interfaces database server 110 to network 108 and may include a modem, an Ethernet interface or any other types of network interface. Database 310 may include one or more repositories of information related to physical locations and music. Database 310 may retrieve music related information when it is presented with location information. Communications interface 312 provides an interface through which the components of database server 110 can communicate.

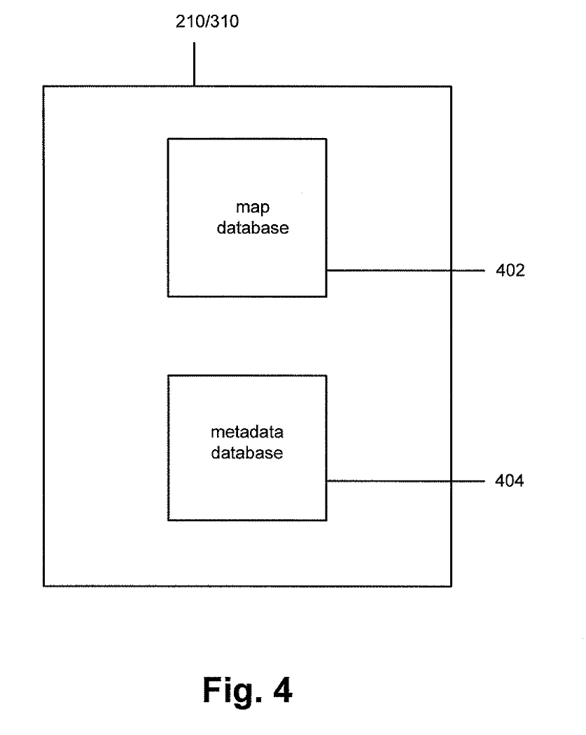

As illustrated in FIG. 4, local database 210 and/or database 310 may include map database 402 and metadata database 404. Local database 210 and database 310 can be organized as tables, records, files, linked lists, or as any other organized data structures that may be searched.

Map database 402 may store geographical keys and location information. A geographical key represents a standard name of a physical location, such as a city, a street, a country, a river or any physical place. Examples of geographical keys include “Stockholm” and “Sweden.” Location information may include data used to locate the position of any physical place in two or three-dimensional space. One example of location information may be coordinates. Coordinates may be expressed as a pair of longitude and latitude or as a triplet including longitude, latitude, and altitude.

Map database 402 may provide location information for each geographical key. Thus, given a user location and a distance, map database 402 can be searched for geographical keys whose locations are within the distance from the user.

Metadata database 404 may store geographical keys and metadata for a music source, which can be a song, album, playlist, radio station, source or collection of pieces of music, or reference to the source or collection. For example, a music source may be a copy of the song Honey, Honey by ABBA on a host computer in the Internet. Its metadata may contain specific information about the copy of song Honey, Honey on the host.

Metadata database 404 may provide a set of geographical keys for each music source. Thus, given a geographical key, metadata database 404 can be searched for music sources that are associated with the geographical key. Metadata database 404 may also be used as a repository to store user-created metadata about music sources and to store user-selected geographical keys for the metadata.

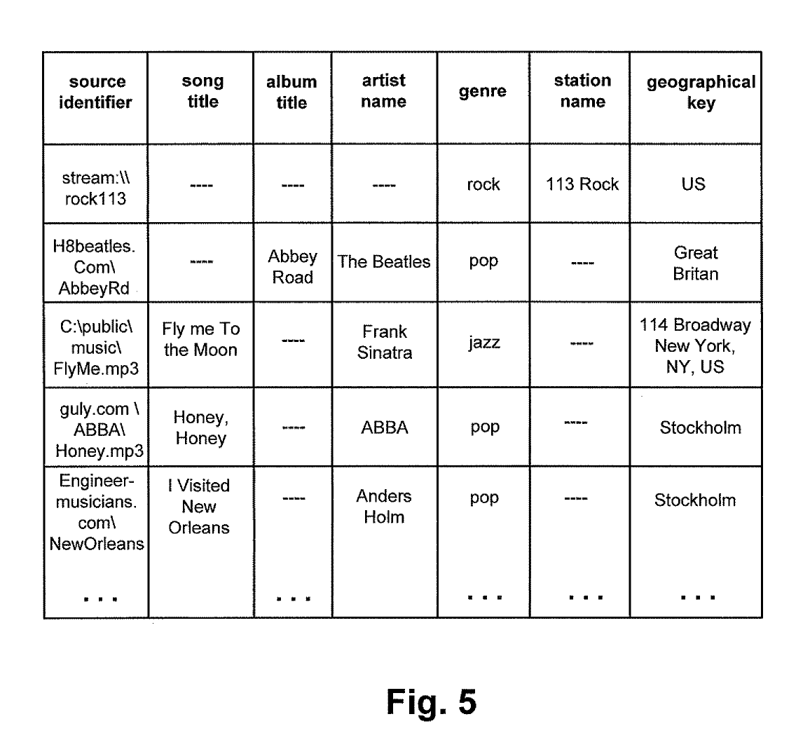

FIG. 5 shows a tabular representation of metadata database 404. A row in the table of FIG. 5 includes fields for metadata and a geographical key for a music source. The row has fields for a source identifier, song title, album title, artist name, genre to which the music source belongs, and geographical key. A source identifier may provide a representation of an address of the music source and allows a device or a user to locate and access the music source. A song title is the name of the music source when the music source is a song; if the music source is not a song, the song title field may be blank. An album title, artist name, genre, and station name may characterize a music source in a manner similar to the song name. The geographical key may represent the name of a specific physical location or geographical region that is associated with the music source.

While FIG. 5 shows an exemplary set of metadata fields for a music source, it is possible to implement a different set of fields. For instance, a row in FIG. 5 may be modified to include fields for “duration,” which indicates the duration of a song, and “year,” which indicates the year at which a song is written.

### Exemplary Music Search

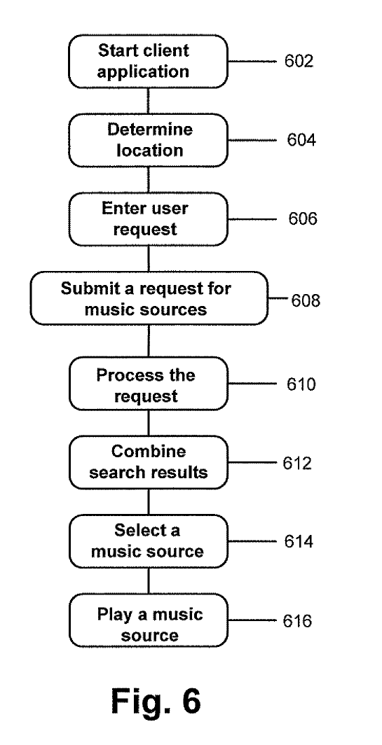

FIG. 6 shows a flowchart for requesting and processing music sources. At block 602, a client application may be started either automatically or when instructed by a user at portable electronic device 102. After the application starts, signals from position signal provider 104 may be captured and used to determine the location of portable electronic device 102 (block 604). The location may be periodically re-determined. When a user wants to listen to a song or a piece of music associated with physical places of interest, using input/output devices 212 (FIG. 2), the user may input a request for music sources into the application (block 606). Entering the request may be as simple as pressing a key or may entail inputting optional parameters related to music sources (e.g., genre, artist name) and/or a distance, which measures, from the user, the range within which the physical places of interest are located. In addition, the user can input location information when it is not provided by portable electronic device 102 or when the user wishes to override the location information that is already produced by portable electronic device 102.

At block 608, the request may be submitted to local database 210 and/or database 310. If the user inputs indicate that some further processing is to be performed at database server 110, the location information and/or the user inputs may be transmitted, as a request for music sources, to database server 110.

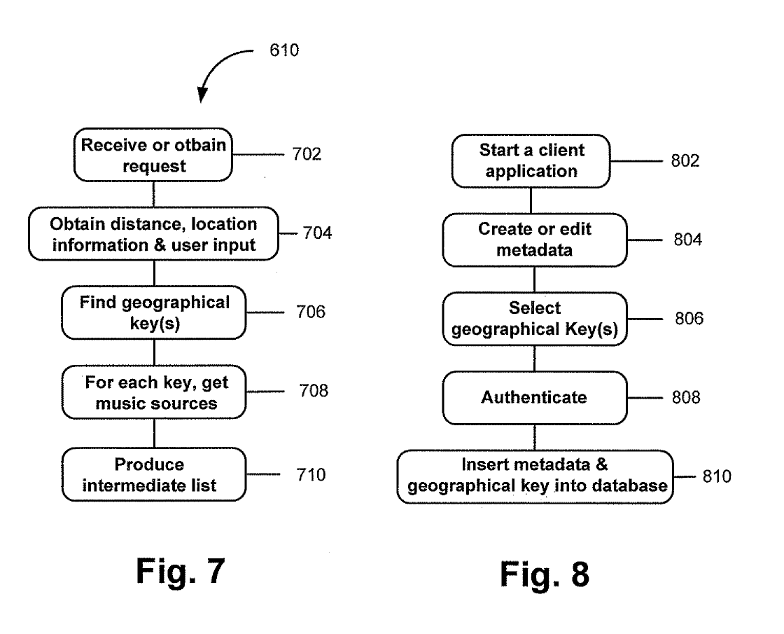

Depending on the client application configuration and/or the user inputs, the request may be processed locally at portable electronic device 102 and/or remotely at database server 110 (block 610). FIG. 7 illustrates a flowchart for processing the request for music sources. At block 702, the request may be received or obtained at database 210/320. At block 704, the distance, user inputs, and location information may be obtained from the request. If the distance is not explicitly provided, a default distance can be used. Based on the distance and location information, a search against map database 402 may be performed to find a list of geographical keys (block 706). The search can yield a list of keys rather than a single key, because there can be many geographical keys whose corresponding physical places are within the distance from the location. Optionally, the list of geographical keys can be presented to a user to allow the user to select a particular geographical key (not shown).

At block 708, a search against metadata database 404 may be performed for each geographical key. Each search may yield a list of music sources. In the search scheme of this embodiment, each geographical key may be matched against the geographical keys of the music sources. However, it is also possible to extend the search scheme, to account for the user inputs and/or different key matching requirements. For example, if the user inputs included the term jazz, the search can further narrow the returned list of music sources to those whose genre field contains the term jazz. If the matching requirement is not based on exact spelling, but based on similarities in meaning, in phonetics, or in etymology between the inputted word and a term in genre metadata field, the user could have inputted jazzy or jaz in place of jazz to narrow the search.

At block 710, the lists of music sources from performing searches based on the geographical keys may be combined to produce a local intermediate list at portable electronic device 102 and/or a remote intermediate list at database server 110. If a remote intermediate list is produced at database server 110 and no search is performed at portable electronic device 102, the remote intermediate list may be transmitted to portable electronic device 102, where the remote intermediate list may become a final list. If no search is performed at database server 110 and a local intermediate list is produced at portable electronic device 102, the local intermediate list may become the final list. If the local and remote intermediate lists are both produced at portable electronic device 102 and database server 110, the remote intermediate list may be transmitted to portable electronic device 102, where the local and remote intermediate lists may be combined (block 612, FIG. 6) to yield the final list. The final list may be presented to the user, who may select a music source (blocks 614).

A selected music source may be played by portable electronic device 102 (block 616), but how the music source is “played” depends on the music source. For example, if the music source is a song that is stored at portable electronic device 102, the song may be “played” by a media application running on portable electronic device 102. If the music source is a song that is stored at a remote database server or at a remote portable electronic device, “playing” may entail downloading or streaming the song. If the music source is a radio station, “playing” the music source may result in starting a radio application that receives an audio stream from a particular station.

### Exemplary Database Creation And Modification

In the above embodiment, a user may have the ability to create or edit portions of local database 210 and/or remote database 310. FIG. 8 illustrates exemplary process for creating or editing portions of databases 210/310 of FIG. 4.

At block 802, a client application may be started either automatically or when instructed by a user. Using the client application, metadata for a music source may be created or edited at block 804. Depending on user inputs, a list of geographical keys may be presented to the user, who can select at least one geographical key for the created or edited metadata (block 806). At block 808, the user may be asked to meet a required level of authentication to modify database(s). If there is no authentication requirement, block 808 is not performed. If the user is authenticated, at block 810, the geographical key and the metadata may be inserted into local database 210 and/or database 310.

In the above, a user creates or edits portions of local database 210 and/or database 310. However, it is also possible to have content owners, distributors, or providers of music sources to perform a similar function.

### Alternative Implementations

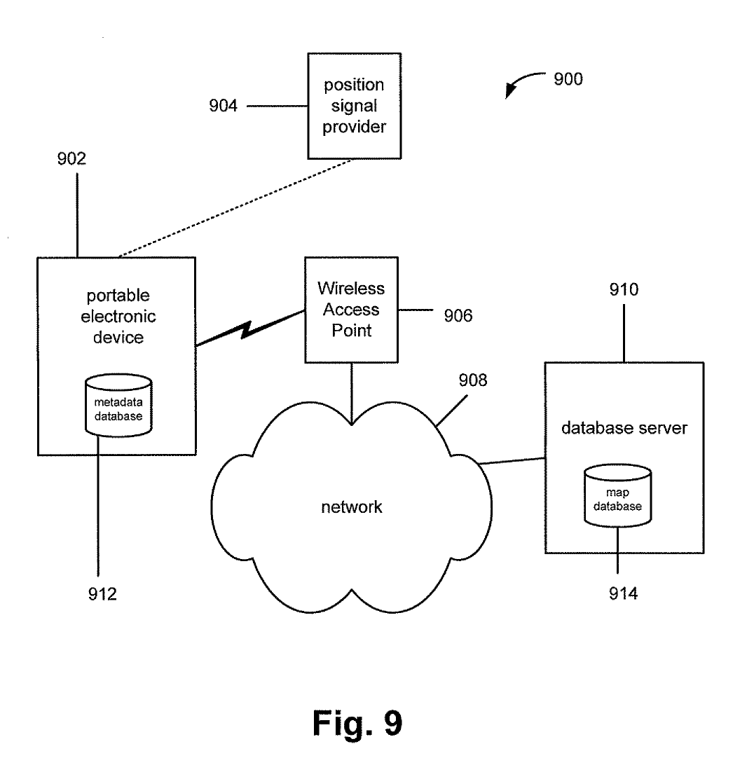

FIG. 9 illustrates another exemplary network 900 in which systems and methods described herein can be implemented. Network 900 may include portable electronic device 902, position signal provider 904, WAP 906, network 908 and database server 910. In practice, network 900 may include more or fewer portable electronic devices, position signal providers, WAPs, networks and/or database servers.

Portable electronic device 902 may be configured similar to portable electronic device 102 and may include elements that are depicted in FIG. 2, except for local database 210. In place of local database 210, portable electronic device 902 may include metadata database 912. Further, portable electronic device 902 may perform a process similar to that performed by portable electronic device 102, except that portable electronic device 902 may not transmit a request for music information to database server 910. Instead, portable electronic device 902 may transmit a request for map information to database server 910.

Position signal provider 904, WAP 906 and network 908 may be configured similar to position signal provider 104, WAP 106, and network 108 as described above with respect to FIG. 1. Position signal provider 904, WAP 906 and network 908 may perform similar functions that are performed by the corresponding elements in FIG. 1.

Database server 910 may be configured similar to database server 110 and may include elements that are depicted in FIG. 3, except for database 310. In place of database 310, database server 910 may include map database 914. Database server 910 may perform a process similar to that performed by database server 110, except that database server 910 may not receive a request for music information from portable electronic device 902. Instead, database server 910 may receive a request for map information and provide map information to portable electronic device 902.

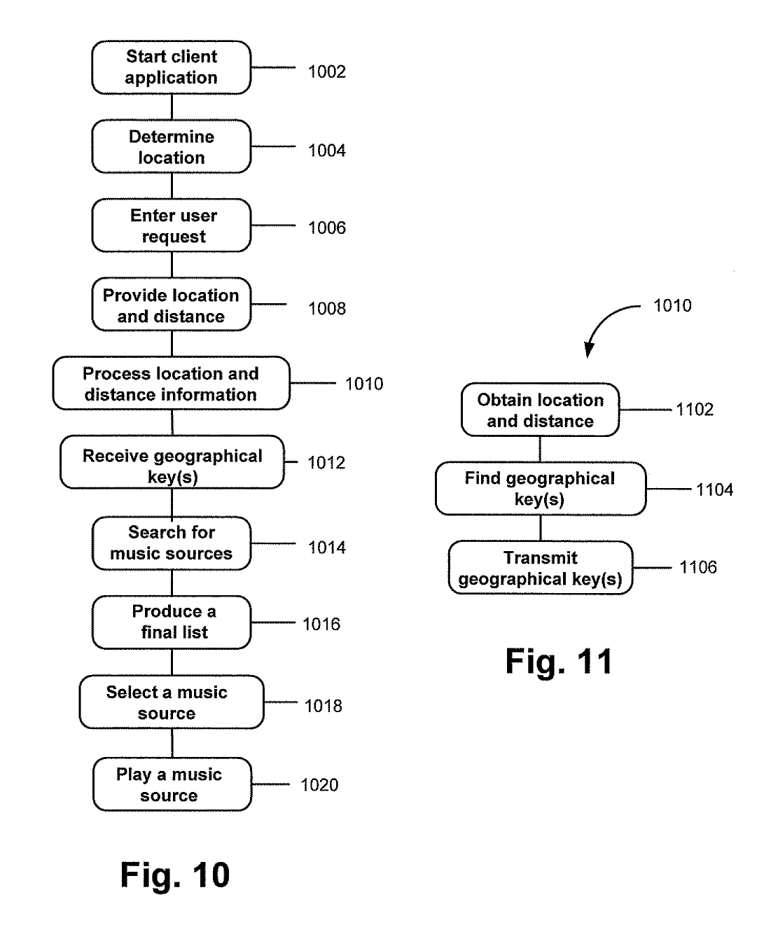

FIG. 10 shows a flowchart of a process for requesting music sources using portable electronic device 902 of FIG. 9. At block 1002, a client application may be started either automatically or when instructed by a user at portable electronic device 902. After the application starts, signals from position signal provider 904 may be captured and may be used to determine the location of portable electronic device 902 (block 1004). The location may be periodically re-determined. When a user wants to listen to a song or a piece of music associated with physical places of interest, using input/output devices 212 (FIG. 2), the user may input a request into the application (block 1006). Entering the request may be as simple as pressing a key or may entail inputting optional parameters related to music sources (e.g., genre, artist name) and a distance. In addition, the user can input the location information when it is not provided by portable electronic device 902 or when the user wishes to override the location information already produced by portable electronic device 902. At block 1008, the location and/or distance information may be provided to database server 910.

FIG. 11 illustrates a flowchart for processing the location and/or distance information (block 1010) at database server 910. At block 1102, the location and/or distance information may be obtained. If the distance is not explicitly provided, a default distance can be used. Based on the location information and the distance, a search against map database 914 may be performed to find a list of geographical keys (block 1104). The geographical keys may be transmitted to portable electronic device 902 at block 1106. Optionally, the geographical keys can be presented to the user to allow the user to select a particular geographical key (not shown).

Referring back to FIG. 10, at block 1012, geographical keys are received by portable electronic device 902. At block 1014, a search for music sources against metadata database 904 may be performed for each geographical key. Each search may yield a list of music sources. In the search scheme of this embodiment, each geographical key may be matched against the geographical keys of the music sources. However, it is also possible to extend the search scheme, to account for the user inputs and/or different matching requirements. At block 1016, the lists may be combined to produce a final list. The final list may be presented to the user, who may select and play a music source (blocks 1018 and 1020).

### EXAMPLE

The following example illustrates a process involved in requesting music sources in accordance with implementation described with respect to FIG. 1.

After powering up, a client application is started on a portable electronic application. The location of the portable electronic device is determined based on signals from Global Positioning System (GPS) satellites. Periodically, the location is re-determined based on a new set of signals from the satellites.

When user Joe Donut arrives at Stockholm, he wants to obtain songs associated with the city. Joe enters a request using a keypad that may be provided with the portable electronic device. Joe enters a distance of 10 km. The portable electronic device accesses its latitude and longitude, of 59.20 N and 18.03 E, computed based on the GPS signals and transmits the location of 59.20 N and 18.03 E and the distance of 10 km to a database server.

Upon receiving the location of 59.20 N and 18.03 E and the distance of 10 km, the database server searches its map database for geographical keys. The search yields “Stockholm” as its geographical key. “Stockholm” is used as a search key into a metadata database, which yields a list of two music sources, Honey, Honey and I visited New Orleans, songs that already have been associated with Stockholm by Joe Donut prior to his arrival at Stockholm. FIG. 5 shows metadata for Honey, Honey and I visited New Orleans. The database server transmits the list of music sources to the portable electronic device. When the portable electronic device receives the list, it displays the list on its screen. The user selects the song Honey, Honey, and the portable electronic device downloads the song, in accordance with its source identifier metadata field. The portable electronic device can then play the song.

### Conclusion

The foregoing description of embodiments provides illustration, but is not intended to be exhaustive or to limit the embodiments to the precise form disclosed. Modifications and variations are possible in light of the above teachings or may be acquired from practice of the teachings.

For example, while a series of blocks have been described with regard to processes illustrated in FIGS. 6, 7, 8, 10 and 11, the order of the blocks may be modified in other implementations. Further, non-dependent blocks may represent acts that can be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the invention have been described as “logic” that performs one or more functions. This logic may include hardware, such as an application specific integrated circuit or a field programmable gate array, software, or a combination of hardware and software.

What is claimed is:

1. A method comprising:
determining location information that identifies a location of a portable device;
making a request that includes the location information to a database;
obtaining a list of music sources associated with the location information from the database as a result of a search performed based on the request;
selecting a music source from the list; and
outputting an audio signal associated with the selected music source.

2. The method as in claim 1, wherein determining location information includes:
receiving signals from Global Positioning System (GPS) satellites or one or more base stations; and
determining the location information based on the received signals.

3. The method as in claim 1, further comprising:
editing or creating a database record that includes a set of metadata for a music source and a geographical key; and
adding or saving the database record to the database.

4. The method as in claim 3, further comprising:
authenticating a user of the portable device at the database before editing, creating, adding or saving the database record.

5. A method comprising:
determining location information that identifies a location of a portable device;
transmitting a request that includes the location information to a remote map database;
receiving a geographical key from the remote map database as a result of a search performed based on the request;
submitting a query based on the geographical key to a local metadata database;
obtaining a list of music sources associated with the location information from the local metadata database as a result of the query; and
outputting an audio signal associated with the selected music source.

6. A portable electronic device comprising:
a position signal receiver for determining location information that identifies a location of the portable electronic device;
one or more processors configured to:
submit a query to a database, the query including the location information;
accept a list of music sources associated with the location information from the database as a result of the query submitted to the database; and
select a music source from the list,
wherein the portable electronic device produces an audio signal associated with the selected music source when the music source is selected from the list.

7. The portable electronic device as in claim 6, wherein the database is included in a remote server.

8. The portable electronic device as in claim 6, wherein the database is included in the portable electronic device.

9. The portable electronic device as in claim 6, wherein the processor is further configured to accept user inputs and wherein the query further includes user inputs.

10. The portable electronic device as in claim 9, wherein the user inputs include one or more of the following: a distance or location information.

11. The portable electronic device as in claim 6, wherein the database includes a map database and a metadata database.

12. The portable electronic device as in claim 11, wherein the metadata database includes a record, the record comprising a geographical key and a set of metadata for a music source.

13. The portable electronic device as in claim 11, wherein the map database includes a record, the record comprising location information and a geographical key that corresponds to the location information.

14. The portable electronic device as in claim 13, wherein the query further includes a distance for obtaining geographical keys whose locations fall within the distance from the location of the portable electronic device.

15. A database server comprising:
a network interface, through which the database server communicates with a portable electronic device that is configured to send a request for a list of music sources, the request including a location of the portable electronic device; and
one or more processors configured to:
receive the request from the portable electronic device,
submit a music query for a list of music sources to a database, the music query including the location of the portable electronic device, and
obtain a list of music sources associated with the location as a result of submitting the music query,
wherein the database server is configured to transmit the list of music sources obtained from the music query to the portable electronic device through the network interface.

16. The database server as in claim 15, wherein the database comprises a map database and a metadata database.

17. The database server as in claim 16, wherein the map database includes a geographical record, the geographical record including location information and a geographical name, and
wherein the metadata database includes a metadata record, the metadata record including a set of metadata for a music source and a geographical name associated with the music source.

18. A device comprising.
means for determining location information that identifies a location of the device;
means for submitting a request that includes the location information of the device to a remote device;
means for accepting records of metadata about music sources associated with the location information from the remote device based on the request;
means for selecting a music source whose record is among the accepted records; and
means for generating an acoustic signal associated with the selected music source.

19. The device as in claim 18, wherein the remote device includes:
means for storing and searching geographical records, at least one geographical record including location information and a geographical name, and
means for storing and searching metadata records, at least one metadata record including a set of metadata for a music source and a geographical name associated with the music source.

20. A remote server comprising:
means for receiving a request for a list of music sources from a device, the request including location information that identifies a location of the device;
means for searching a database for a list of music sources associated with the location information; and
means for transmitting the list of music sources obtained from searching the database to the device.
